(19) United States
(12) Patent Application Publication
(10) Pub. No.: US 2018/0222396 A1
(43) Pub. Date: Aug. 9, 2018

(54) ROOF RAIL FOR A MOTOR VEHICLE, MOTOR VEHICLE HAVING A ROOF RAIL, AND METHOD FOR PRODUCING A ROOF RAIL

(71) Applicant: Suddeutsche Aluminium Manufaktur GmbH, Böhmenkirch (DE)

(72) Inventors: Hans BINDER, Böhmenkirch (DE); Ottmar BINDER, Böhmenkirch (DE); Stefan SIRRENBERG, Wuppertal (DE); Rolf VETTER, Birenbach (DE)

(73) Assignee: Suddeutsche Aluminium Manufaktur GmbH, Böhmenkirch (DE)

(21) Appl. No.: 15/741,601

(22) PCT Filed: Jul. 6, 2016
(86) PCT No.: PCT/EP2016/066020

§ 371 Date: Jan. 3, 2018

(30) Foreign Application Priority Data
Jul. 7, 2015 (DE) 10 2015 212 684.6

(51) Int. Cl. B60R 9/04

(52) U.S. Cl. CPC B60R 9/04

(57) ABSTRACT

A roof rack for a motor vehicle has at least one roof rack bar extending along the roof of the motor vehicle. The roof rack bar is a longitudinally divided roof rack bar and is made of a plurality of individual bars which are fixed to each other. Furthermore, the invention relates to a motor vehicle having a roof rack, and to a method for the production of the roof rack.

The invention relates to a roof rack for a motor vehicle, having at least one roof rack bar extending along the roof of the motor vehicle.

A roof rack of the type mentioned is known. The known roof rack particularly has two roof rack bars which are mounted running parallel to each other on a roof of a motor vehicle. The roof rack offers the possibility of fastening loads on the roof of the vehicle. In most cases, additional equipment which is attached to the roof rack, such as a bicycle rack, ski case attachment, and so on, is required for this purpose. The known roof rack is not flexible in terms of its visual appearance, its design, and its technical characteristics.

The problem addressed by the invention is that of providing a roof rack for a motor vehicle, which can be easily adapted to a variety of requirements.

This problem is addressed according to the invention, for a roof rack of the type mentioned above, in that the roof rack bar is a longitudinally divided roof rack bar and is composed of a plurality of individual bars which are fixed to each other. Accordingly, the visual appearance, the design, and/or the technical characteristics of the roof rack can be varied very easily and flexibly by combining corresponding individual bars together and assembling them into the roof rack bar. A “longitudinally divided roof rack bar” is to be understood as meaning a bar which has a longitudinal joint running along its longitudinal extension, and/or longitudinal joints running in such a manner. The longitudinal joint or the longitudinal joints are formed between the individual bars. In general, these joints are not visible, or not immediately visible. Rather, the individual bars abut each other without gaps. Additionally or alternatively, however, a longitudinal joint which forms a visible gap can be included—for example, in some sections—between the individual bars. By selecting corresponding individual bars with regard to their visual, design and technical properties, the roof rack bar formed therefrom will have corresponding properties. For example, it is possible to combine individual bars of different material and/or different visual appearance with each other to form the roof rack bar. Consequently, due to the invention, a roof rack is created which has a roof rack bar or roof rack bars which can be modified by the manufacturer, easily and in many ways, to meet the given wishes/requirements. Since the individual bars are fixed to each other, and in particular are bolted together by means of bolts, a solid cohesion is produced—that is, a roof rack bar is produced which has very good load characteristics, which are defined according to the choice of the selected individual bars. For example, it is possible to combine individual bars of different materials and/or different cross-sectional contours—the latter in relation to the respective outer contour and/or optionally inner contour (in a hollow profile, a plurality of hollow profiles, a solid profile, a plurality of solid profiles, and/or the combination of at least one hollow profile and at least one solid profile). The longitudinally divided roof rack bar composed of individual bars is also very easy to assemble in the desired manner with regard to the visual properties thereof. As such, different colors, different surfaces, different structures, different anodized surfaces and/or different coatings, and of course any given combinations of these features, can be created by a corresponding combination of individual bars.

According to an implementation of the invention, the individual bars each have upper and lower sides, wherein the lower side of an individual bar is placed on the upper side of at least one of the adjacent individual bars. In this case, said individual bars preferably run parallel to each other (slight deviations from this should also be subsumed under the idea of a “parallel course”).

According to an implementation of the invention, the upper side and/or the lower side of at least some of the adjoining individual bars have interlocking profilings. In this way, the individual bars are aligned with each other in a manner which prevents slipping, their attachment to each other is thereby facilitated, and the load capacity is further increased. In particular, the interlocking profilings improve the absorption of transverse forces exerted on the roof rack bar—that is, forces exerted transversely to the longitudinal extension of the roof rack bar.

According to an implementation of the invention, one of the profilings has at least one projection, in particular at least one rib extending over the length of the individual bar, forming the projection, and the other profiling has at least one depression which receives the projection—in particular, a groove extending over the length of the single bar, forming the depression.

According to an implementation of the invention, the longitudinally divided roof rack bar is a two-part roof rack bar with one individual bar forming an upper part and one individual bar forming a lower part. The roof rack bar is therefore composed of two individual bars.

The individual bars can be of the same design; however, they are preferably different in design, particularly having different dimensions, cross-sectional contours, materials and/or shapes, and so on.

In an implementation of the invention, the individual bars are connected to each other by means of—in particular—a plurality of connections, particularly distributed over their length. This ensures strong overall cohesion. High bending stiffness is also achieved in this way.

The connections can—according to corresponding embodiments of the invention—be designed as bolted connections, rivet connections, and/or sliding block connections. With regard to the bolted connections, threaded bolts are particularly used which pass through at least one individual bar and are bolted into threaded holes of at least one other individual bar. However, bolts equipped with nuts, wherein the shanks of the bolts pass through mounting holes of the relevant individual bars, can also be contemplated. Accordingly, rivets can be used, with which the individual bars are connected to each other. The sliding block connections mentioned above are specifically fastening devices which each have a sliding block which is inserted into a corresponding receptacle of an individual bar, and have a fastening bolt, or allow the fastening of a fastening bolt, wherein at least one adjacent individual bar is held by the fastening bolt. For example, a sliding block can have a threaded hole into which a threaded bolt, which forms a fastening bolt, is bolted, the same passing through a mounting hole of at least one adjacent individual bar. Or, the sliding block has a threaded bar attached to the same in a torque-proof manner, which passes through a mounting hole of the at least one adjacent individual bar, with a fastening nut bolted onto the same to firmly clamp the at least two individual bars to each other.

According to an implementation of the invention, the individual bars have the same length and/or different lengths. Preferably, the roof rack bar is curved on both of its end regions, in such a manner that its height is reduced as it extends over the roof of the motor vehicle. Consequently, the end areas run out with decreasing heights due to the curves. As a result, the longitudinally divided roof rack bar composed of individual bars preferably has individual bars with different lengths. If one considers, for example, a roof rack bar which is composed of two individual bars connected to each other, the length of the upper individual bar is greater than the length of the individual bar positioned under the same, such that the upper individual bar covers the underlying individual bar at its end regions.

According to an implementation, the upper part is longer than the lower part, and/or the at least one upper individual bar is longer than at least one lower individual bar. This has already been explained above.

The roof rack according to the invention is preferably designed in such a manner that it has no foot braces—that is, the at least one rack bar does not run at a distance from the roof of the motor vehicle, said distance being created by foot braces. Rather, when the vehicle is viewed from the side, the roof rack bar projects beyond the roof of the vehicle substantially by the height/thickness of the roof rack bar. The lower side of the roof rack bar follows the contour of the roof, wherein particularly no, or particularly no appreciable, gap is formed between the roof contour and the lower side of the roof rack bar. Alternatively, however, the invention can also be realized with a roof rack wherein the at least one roof rack bar runs at a distance to the roof of the motor vehicle. For this purpose, at least one foot brace is preferably included which creates the distance from the roof rack bar to the roof of the motor vehicle. Nevertheless, the roof rack bar according to the invention can therefore have a longitudinally divided design and can be composed of a plurality of individual bars connected to each other.

In particular, the individual bars—seen in cross-section—have different widths. In this way, it is preferably possible for the uppermost roof rack bar, which is thus furthest removed from the roof of the motor vehicle, to have a greater width than at least one roof rack bar positioned below the same. As a result, the visual impression is created that the lower individual bar serves as a support structure for the upper individual bar. However, the lower individual bar is not to be regarded as a simple fastening element for the upper individual bar. Rather, the lower individual bar forms, together with the upper individual bar, the longitudinally divided roof rack bar, which in total corresponds to the roof rack bar known from the prior art—which is made of a single piece rather than being divided longitudinally.

The width of the upper part is preferably greater, as seen in cross-section, than the width of the lower part on the upper side thereof. This has already been explained above.

According to an implementation of the invention, at least one pocket is formed on the lower side of at least one of the roof rack bars, wherein an end region of an adjacent individual bar engages with the same. Preferably, a pocket is formed on the lower side of said individual bar, in each of the two end regions thereof. The ends of the adjacent individual bar arranged underneath engage with the respective pocket, and are positioned in this way. As a result, a relative displacement of the two individual bars in the longitudinal direction of the roof rack bars is not possible. The pocket(s) therefore enable(s) a reproducible assignment of the individual bars to each other and pre-vent(s) a relative displacement relative to each other.

Preferably, the individual bars are designed as hollow profiles. It can also be contemplated, of course, that solid profiles are used, or that the roof rack bar consists of at least one individual bar which is designed as a hollow profile and at least one individual bar which is designed as a solid profile.

The individual bars are preferably extruded individual bars. The latter is true regardless of whether they are manufactured as hollow profiles or as solid profiles. The extrusion is performed in the direction of the longitudinal extension of the respective individual bar, and allows a very simple and cost-effective production.

In particular, the individual bars consist of aluminum or an aluminum alloy, and in particular are aluminum profiles or aluminum alloy profiles, preferably extruded aluminum profiles or extruded aluminum alloy profiles.

In an implementation of the invention, at least one adapter for attachment to the roof, in particular to the body of the motor vehicle, is arranged—in particular, fastened, preferably bolted, riveted, and/or fastened with a sliding block—on the lower side of the undermost individual bar. This adapter is connected, on the one hand, to the at least one individual bar, and on the other hand to the roof—in particular the vehicle body. Preferably, the adapter is arranged in a so-called roof channel of the motor vehicle. In particular, there is a plurality of adapters per roof rack bar, distributed over the length of the roof rack bar.

According to an implementation of the invention, the individual bars are made of different materials. This also means that, for example, different aluminum alloys can be used for the individual bars. Of course, completely different materials can be used for the individual bars.

According to an implementation of the invention, at least one of the individual bars is made of plastic—and in particular is a plastic profile, preferably an extruded plastic profile or a plastic molded part. The plastic profile is preferably produced by extrusion, or is produced as a plastic molded part—that is, is manufactured in a mold. In particular, at least one lower individual bar, in particular the lower part, is made of plastic, and at least one upper individual bar, in particular the upper part, is made of aluminum or an aluminum alloy, wherein this lower individual bar and this upper individual bar optionally form the roof rack bar with other individual bars,

The individual bars particularly have different colors, different surface structures, and/or different coatings on their visible surfaces. This strongly influences the visual impression of such a roof rack bar. These measures are provided for the visual effect—as mentioned—in particular on the visible surfaces of the individual bars. Additionally or alternatively, of course, the individual bars of a profile bar can have, as a whole—that is, on all their surfaces—different colors, different surface structures, and/or different coatings.

In the two-part roof rack bar having a lower part and an upper part, the arrangement is made such that the lower part supports the upper part. In particular, the lower part is attached to the roof—in particular, the body of the motor vehicle—and the upper part is attached to the lower part.

In an implementation of the invention, the individual bars are each constructed in one piece.

In the longitudinally divided roof rack bar according to the invention, which is composed of a plurality of individual bars attached to each other, the at least one dividing joint extends between the separate, individual bars in the longitudinal direction of the roof rack bars. Specifically, the dividing joint—when the roof rack is in the position of use—is oriented horizontally or substantially horizontally. Additionally or alternatively, of course, the dividing joint can have a different orientation—for example, running vertical or substantially vertical. In the first case, the upper region of the roof rack bar is formed by at least one individual bar other than the lower region of the roof rack bar. In the second case, one side of the roof rack bar is formed by at least one individual bar other than the other side. Dividing joints which have an angle of inclination to the horizontal or vertical are also the subject matter of the invention. Also, any combination of the different dividing joints mentioned above is possible. Preferably, the arrangement is made in such a manner that the at least one dividing joint does not lead to a visible distance of the individual bars attached to each other, and rather is closed and/or not visible.

For the roof rack bars according to the invention, the individual bars are preferably arranged one above the other when the roof rack bar is in the position of use. At least two individual bars are included in this arrangement. Alternatively, however, it can also be contemplated that the individual bars—when the roof rack bar is in the position of use—are not arranged one over the other, but rather next to each other. Again, at least two individual bars are included for this adjacent arrangement. Another alternative is to arrange individual bars both one above the other and next to each other. This requires at least three individual bars, wherein two individual bars are positioned next to each other and one individual bar is arranged above the same—for example above one of the lower, above the other lower, or above both of the lower individual bars. The above explanations show that it is possible to realize this joining of individual bars which are connected to each other, to thereby form a roof rack bar according to the invention, in many variations—especially when an even greater number of individual bars is used.

The invention further relates to a motor vehicle which is equipped with a roof rack as described above in the various embodiments.

Furthermore, the invention relates to a method for the production of a roof rack for a motor vehicle—in particular a roof rack as described above in the various variations. This roof rack is equipped with at least one roof rack bar extending along the roof of the vehicle, wherein the roof rack bar is composed of a plurality of individual bars to form a longitudinally divided roof rack bar. “Longitudinally divided” means that the at least one dividing joint extends in the longitudinal extension direction of the roof rack bar. The at least one dividing joint can run horizontally, vertically, or diagonally. A combination of different dividing joints can also be contemplated. This results in a corresponding arrangement of individual bars per roof rack bar.

The drawings illustrate the invention by means of embodiments, wherein:

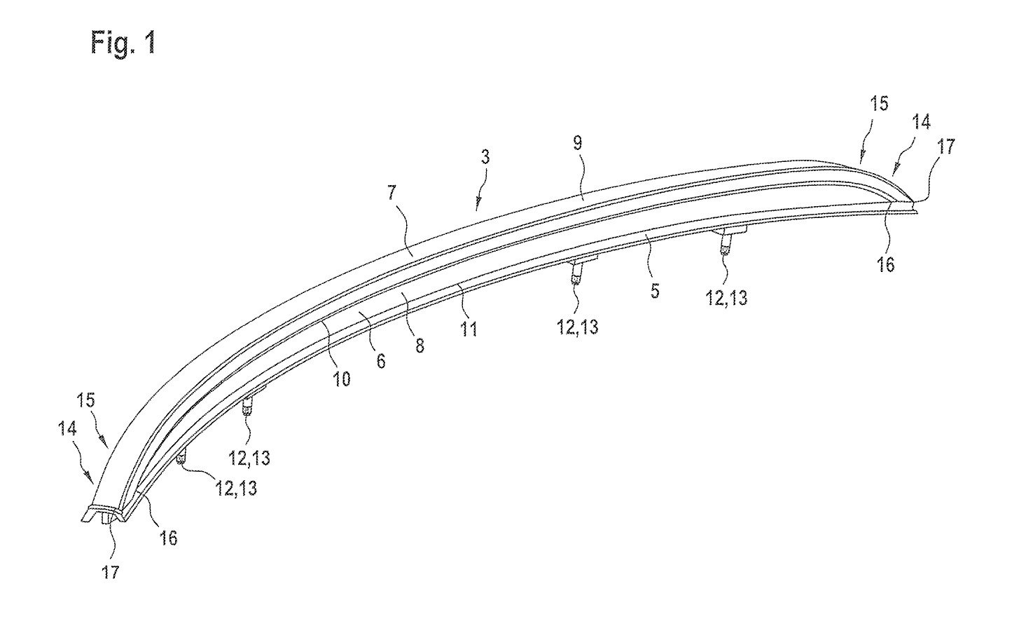

FIG. 1 shows a perspective view of a roof rack bar of a roof rack for a motor vehicle,

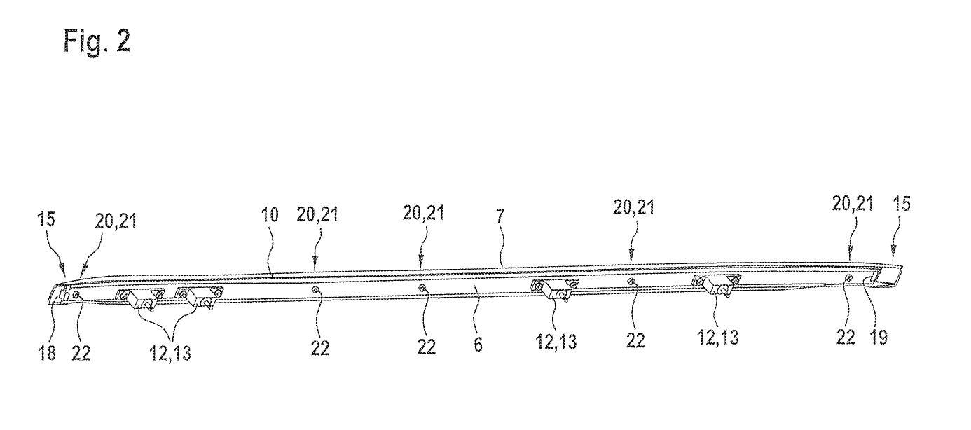

FIG. 2 shows a perspective view from below of the roof rack bar of FIG. 1,

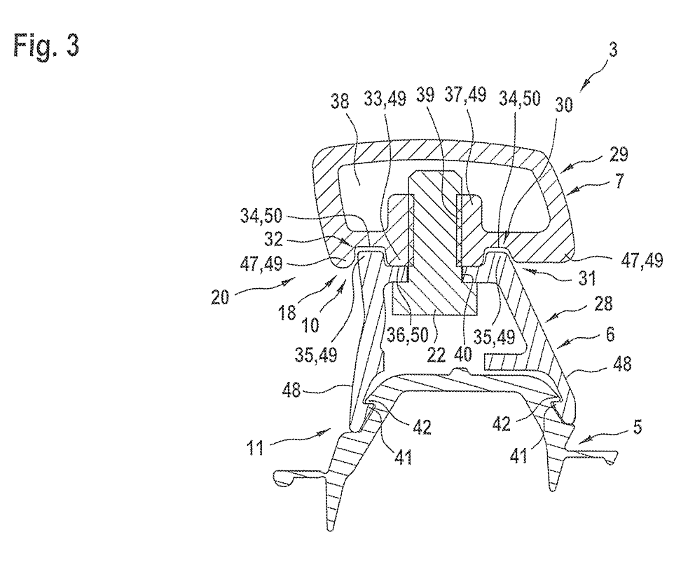

FIG. 3 shows a cross-section of the roof rack bar of FIG. 1, in a first region,

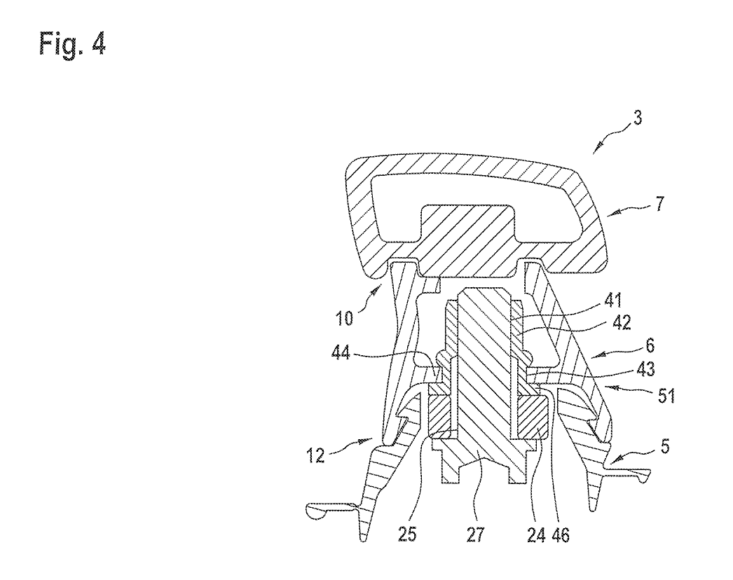

FIG. 4 shows a cross-section of the roof rack bar of FIG. 1, in a second region,

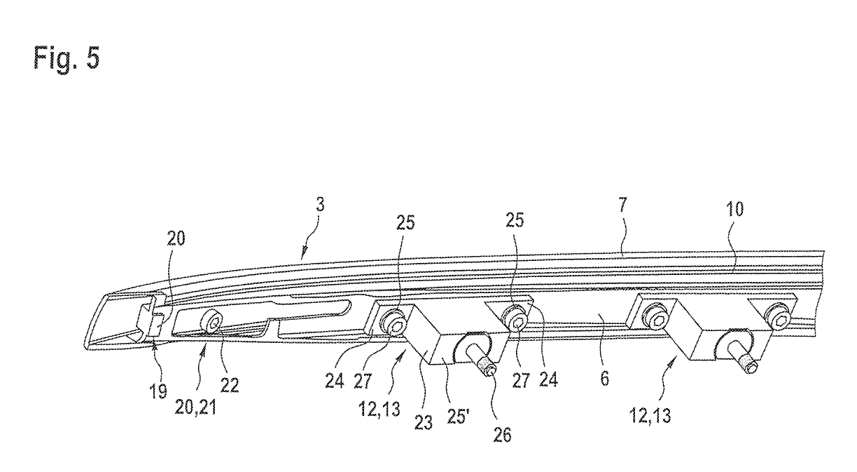

FIG. 5 shows a section of an end region of the roof rack bar of FIG. 2, in a perspective view from below,

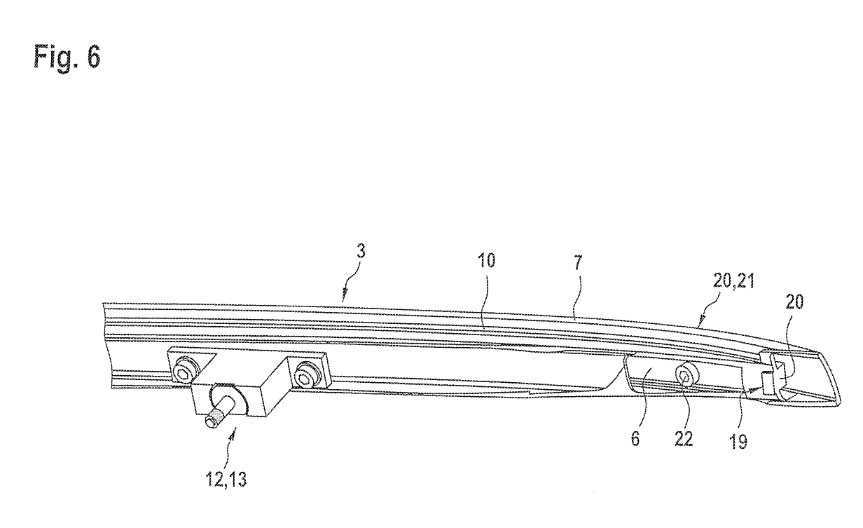

FIG. 6 shows a section of another end region of the roof rack bar of FIG. 2, in a perspective view from below, and

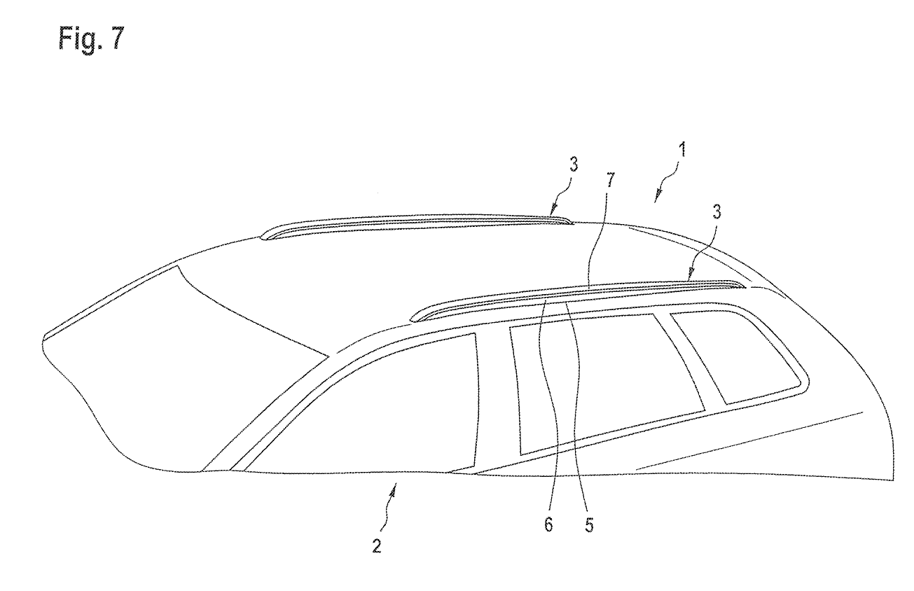

FIG. 7 shows a motor vehicle equipped with a roof rack which has two roof rack bars.

FIG. 7 shows an overview of an embodiment of the roof rack 1 according to the invention for a motor vehicle 2. In the illustrated embodiment, the roof rack 1 has two roof rack bars 3, which are fixed on the roof 4 of the motor vehicle 2 along the longitudinal extent thereof. The roof rack bars 3 are designed with no foot braces—that is, they project beyond the adjacent surface of the roof 4, only by the extent of their height/thickness, wherein the arrangement is preferably made in such a manner that there is no visible clearance between the surface of the roof 4 and the lower side of each roof rack bar 3. This is also the case if any given roof rack bar 3 is fastened in an associated roof channel of the motor vehicle 2. It is optionally possible for an optional pad 5 made of an elastic material to be arranged between the adjacent surface of the roof 4 and the lower side of each roof rack bar 3. This pad 5 only acts as a seal, without displaying any supporting characteristics. It may also be desirable for optical reasons. The pad 5 can be made of, for example, soft plastic such as sponge rubber, neoprene, or the like.

FIG. 1 shows a roof rack bar 3 of the roof rack 1. The additional roof rack bar 3 of the roof rack 1 (FIG. 6) has the same design. The roof rack bar 3 of FIG. 1 is designed as a longitudinally divided roof rack bar 3. In this case, it is composed—in the present embodiment—of two individual bars 6 and 7 which are connected to each other. The two individual bars 6 and 7 are arranged one above the other when the roof rack 1 is in the position of use. Preferably, the lower individual bar 6 forms a lower part 8 and the upper individual bar 7 forms an upper part 9 of the roof rack bar 3. The two individual bars 6 and 7 are each designed as a single piece. Because of their arrangement one above the other, a dividing joint 10 is formed between the individual bars 6 and 7, which, however, is closed. This means that no gap is visible. Rather, the two individual bars 6 and 7 are precisely positioned closely enough to each other that, when the roof rack bar 3 is viewed from the side, no gap (light which comes from the other side) is recognizable. The latter can also be achieved by a clever cross-sectional profiling of the individual bars 6 and 7. The pad 5 mentioned above, which is, however, optional, is arranged on the lower side 11 of the roof rack bar 3—specifically on the lower side 11 of the lowermost individual bar 6. Furthermore, according to FIG. 1, fastening elements 12 which are preferably designed as so-called adapters 13, are fastened to the lower side 11 of the roof rack bar 3. The adapters 13 are used to attach the roof rack bars 3 to the roof 4—in particular, to a vehicle body—of the motor vehicle 2. A plurality of fasteners 12 which can hold the roof rack bar 3 securely on the roof 4 of the motor vehicle 2 are distributed over the length of the roof rack bar 3. The arrangement is made in such a manner that the thickness/height of the roof rack bar 3 decreases towards its two ends 14. This is achieved by the end regions 15 of the roof rack bar 3 being curved in the direction of the roof 4. The consequence of this is that, accordingly, the height/thickness of the individual bars 6, 7 or the height/thickness of at least one of the individual bars 6, 7 decreases toward the ends 14 in the end regions 15. In the illustrated embodiment of FIG. 1, the lower individual bar 6 is shorter than the upper individual bar 7. This is achieved by the end regions 15 of the individual bar 7 covering the ends 16 of the individual bar 6. Accordingly, viewed in the longitudinal direction of the roof rack bar 3, there is a distance between each end 16 of the individual bar 6 and each associated end 17 of the individual bar 7.

The dividing joint 10 runs in the longitudinal direction of the roof rack bar 3 and is oriented horizontally when the roof rack bar is in the position of use 3. Due to the aforementioned curved end regions 15, and optionally the other slightly curved form of the roof rack bar 3, the dividing joint 10 is designed with an accordingly curved shape. This form is also subsumed under the term “horizontal”.

According to FIG. 2, pockets 19 are formed on each lower side 18 of the upper individual bar 7 in the end regions 15 of the roof rack bar 3, and each end 16 of the individual bar 6 is inserted into the same.

This is particularly visible in FIGS. 5 and 6. Each pocket 19 is preferably formed by a ligament 20 which runs with an angle. The ligament 20 is attached to the individual bar 7 or formed integrally with the same. The pockets 19 fix the two individual bars 6 and 7 relative to each other in the longitudinal direction of the roof rack bar 3, such that they cannot be shifted. Preferably, the ends 16 of the individual bar 6 are inserted into the pockets 19 transversely to the longitudinal direction of the roof rack bar 3 and/or through the same, such that the individual bar 6 is slightly elastically bent when inserted, so as to shorten it for a short time for the insertion.

According to FIGS. 2, 5 and 6, the two individual bars 6 and 7 are fixed to each other. This is accomplished in the illustrated embodiment by means of a plurality of connections 20 distributed over the length of the roof rack bar 3, which are formed in the present case as bolted connections 21. Each bolted connection 21 has a threaded bolt 22 which passes through a passage 40 of the individual bar 6 and is tightened into a threaded bore 39 of the individual bar 7 (FIG. 3).

In FIGS. 2, 4, 5 and 6, the structure of the various adapters 13 can be seen clearly. Each adapter 13 has a holding part 23 which has flanges 24 equipped with through-holes 25. A threaded bolt 26 is fastened on the side 25′ of the holding part 23 opposite the flanges 24. The adapters 13 are attached to the roof rack bar 3 and/or the individual bar 6 by means of threaded bolts 27 which pass through the through-holes 25 of the flanges 24 and are tightened into threaded holes 41 of a rivet nut 42 or of the individual bar 6. When the roof rack bar 3 is installed on the roof 4 of the motor vehicle 2, the holding parts 23 attached to the roof rack bar 3 are inserted into a roof channel of the motor vehicle. The threaded bolts 26 engage in mounting holes of the body of the motor vehicle 2. A nut, in particular a lock nut, is tightened down to securely hold the roof rack bar 3 on the roof 4 of the motor vehicle 2.

According to FIG. 3, the two individual bars 6 and 7 are designed as hollow profiles 28, 29. These are preferably extruded hollow profiles—that is, extruded individual bars 6 and 7. The extruded individual bars 6 and 7 are bent and mechanically processed after the extrusion step. In the present embodiment, both hollow profiles 28 and 29 are made of an aluminum alloy. To create a special visual effect, the two individual bars 6 and 7 have different colors. For example, they are anodized differently, in such a manner that different colors appear.

FIG. 3 shows a cross-section of the roof rack bar 3, and the optionally-used pad 5, in the region of a connection 20. It can be seen that the width of the individual bar 7 is greater than the width of the individual bar 6 in the region of the upper side 30 of the latter. A profiling 31/32 is provided on the lower side 18 of the individual bar 7 and on the upper side 30 of the individual bar 6 for the transverse guidance of the two individual bars 6 and 7 relative to each other.

The profiling 31 has a projection 33, and two depressions 34 located on both sides of the projection 33. The profiling 32 has two projections 35 and a depression 36 located between the two projections 36. The arrangement is then made such that, when the lower side 18 of the individual bar 7 is placed onto the upper side 30 of the individual bar 6, the projection 33 dips into the depression 36 and the projections 35 dip into the depressions 34. The projection 33 continues as a further projection 37 in the interior 38 of the individual bar 7, such that there is a great deal of “meat” for the threaded hole 39 on the lower side 18 of the individual bar 7. The through-hole 40 of the individual bar 6 is located in the region of the depression 36 of the individual bar 6. To connect the two individual bars 6 and 7, the threaded bolt 22 is inserted from the lower side 11 of the individual bar 6, passing through the through-hole 40, into the threaded bore 39.

FIG. 3 shows that there are two projections, one on each side of each depression 34—specifically, the aforementioned projection 33 on the one hand, and a further projection 47 on the other. The two projections 47 overlap lateral surfaces 48 of the individual bar 6 and thereby form additional transverse guides.

In particular, the projections 33, 35 and 47 are formed as ribs 49 extending over the length of the respective individual bar 6, 7. The projection 37 can also be designed as such a rib 49. In addition, the depressions 34 and 36 are each designed as grooves 50 extending over the length of the respective individual bar 6, 7. Such ribs 49 and grooves 50 can be manufactured in a very simple manner during the step when the extruded individual bars 6 and 7 are extruded.

In the region of the lower side 11 of the individual bar 6, the latter has stages 41 on opposite sides (FIG. 3), wherein corresponding counter stages 42 of the elastic pad 5 are clipped into the same.

FIG. 4 shows a cross-section of the roof rack bar 3, corresponding to FIG. 3, but in this case in the region of a bolted connection 51 used to fasten a fastening element 12 to the individual bar 6. FIG. 4 shows that the respective threaded bolt 27 is not bolted into a threaded hole directly formed in the individual bar 6, but rather in a threaded bore 41 which is formed in the rivet nut 42, wherein the rivet nut 42 is fastened by riveting in a through-hole 43 of an inner wall 44 of the individual bar 6. The head 45 of the threaded bolt 27 forces the corresponding flange 24 of the holding part 23 against a flange 46 of the rivet nut 42, such that the adapter 13 and/or the fastening element 12 is/are securely held on the individual bar 6.

1. A roof rack for a motor vehicle, the roof rack comprising at least one roof rack bar extending along the roof of the motor vehicle, the roof rack bar is a longitudinally divided roof rack bar and is composed of a plurality of individual bars which are fixed to each other.

2. The roof rack according to claim 1, the individual bars each have upper and lower sides, wherein the upper side of at least one of the individual bars is placed on the lower side of an adjacent individual bar.

3. The roof rack according to claim 2, wherein the upper side and/or the lower side of at least some of the adjacent individual bars have interlocking profiles.

4. The roof rack according to claim 3, wherein one of the interlocking profiles has at least one projection, in the form of at least one rib which extends over the length of the individual bar and forms the projection, and in that the other interlocking profile has at least one depression in the form of a groove which receives the projection and which extends over a length of the individual bar and forms the depression.

5. The roof rack according to claim 1, wherein the longitudinally divided roof rack bar is a two-piece roof rack bar with an individual bar forming an upper part and an individual bar forming a lower part.

6. The roof rack according to claim 1, wherein the individual bars are connected to each other by a plurality of connections distributed over their respective lengths.

7. The roof rack according to claim 6, wherein the connections are bolted connections, rivet connections, and/or sliding block connections.

8. The roof rack according to claim 1, wherein the individual bars have the same or different lengths.

9. The roof rack according to claim 5, wherein the upper part is longer than the lower part.

10. The roof rack according to claim 1, wherein the individual bars as seen in cross-section have different widths.

11. The roof rack according to claim 5, wherein as seen in cross-section a width of the upper part is greater than a width of the lower part on an upper side thereof.

12. The roof rack according to claim 1, further comprising at least one pocket on a lower side of at least one of the individual bars, wherein an end region of an adjacent individual bar engages with the at least one pocket.

13. The roof rack according to claim 1, wherein the individual bars are designed as hollow profiles.

14. The roof rack according to claim 1, wherein the individual bars are extruded individual bars.

15. The roof rack according to claim 1, wherein the individual bars are made of aluminum or an aluminum alloy, and are extruded aluminum profiles or extruded aluminum alloy profiles.

16. The roof rack according to claim 1, further comprising at least one adapter for attachment to the roof, of the motor vehicle, the at least one adaptor is fastened on a lower side of a lowermost individual bar.

17. The roof rack according to claim 1, wherein the individual bars are made of different material.

18. The roof rack according to claim 1, wherein at least one of the individual bars is made of plastic, and in particular is an extruded plastic profile or a plastic molded part.

19. The roof rack according to claim 5, wherein the lower part is made of plastic, and the upper part, is made of aluminum or an aluminum alloy.

20. The roof rack according to claim 1, wherein the individual bars have different colors, different surface structures, and/or different coatings, on visible surfaces.

21. The roof rack according to claim 5, wherein the lower part supports the upper part.

22. The roof rack according to claim 1, wherein the individual bars are each designed as a single piece.

23. The roof rack of claim 1 in combination with a motor vehicle, the roof rack secured to the motor vehicle.

24. A method for the production of a the roof rack for a motor vehicle of claim 1, the method comprising assembling the longitudinally divided roof rack bar from the plurality of individual bars.
